(19) United States
(12) Patent Application Publication
(10) Pub. No.: US 2023/0129849 A1
(43) Pub. Date: Apr. 27, 2023

(54) SMART WORKFLOW ACTION-BASED CHECKLIST

(71) Applicant: VMware, Inc., Palo Alto, CA (US)

(72) Inventors: Mohammed Lazim, Bangalore (IN); Rohit Pradeep Shetty, Bangalore (IN); Chaoting Xuan, Duluth, GA (US)

(21) Appl. No.: 17/507,466

(22) Filed: Oct. 21, 2021

(51) Int. Cl. G06F 40/186; G06F 40/205; G06F 40/134; G06Q 10/10; G06Q 10/00; G06N 20/00

(52) U.S. Cl. CPC G06F 40/186; G06F 40/205; G06F 40/134; G06Q 10/103; G06Q 10/107; G06Q 10/1097; G06Q 10/20; G06N 20/00; G06F 3/04842

(57) ABSTRACT

Systems and methods are described for creating tasks for an action-based checklist. In an example, a checklist system can receive a body of text, such as text from an email, calendar invite, or document. The checklist system can extract words in the text body that correspond to a task description component of stored task templates. Based on the extracted words, the checklist system can identify an applicable task template. The checklist system can parse utterances in the text body and identify an entity value based on example utterances provided in the task template. The checklist system can insert the entity value into placeholders in the task template and generate task from the task template. The checklist system can add the task to a checklist that is provided to a user device.

### BACKGROUND

Employees of businesses are frequently asked to perform tasks by other employees or clients. The requests for these tasks often come in the form of emails, instant messages, calendar invites, and other text-based mediums. It can be difficult for employees to keep track of all the tasks that need to be performed on top of the daily responsibilities.

Some systems have implemented contextual notifications to help employees keep track of tasks. However, these notifications usually consist of single step actions like approving a request or providing an interface to comment on a ticket. These notifications are inherently restricted to a single action provided by a third-party backend.

Also, employees in enterprises often end up performing a set of similar tasks at various junctures, such as when a new employee joins the company or when an employee joins a new project. Currently, an employee receives information about such repetitive tasks informally or the employee must refer to a manually created document checklist if such documentation even exists. This is both inconvenient and increases the risk of an employee skipping a step or willfully not complying, which can lead to future complications.

As a result, a need exists for dynamically created intelligent, action-based checklists that can be assigned to users.

### SUMMARY

Examples described herein include systems and methods for creating tasks for an action-based checklist. In an example, a checklist system can receive a body of text. The body of text can come from content associated with, or directed to, a user of a user device. Some examples of content include an email, a calendar invite, a trouble ticket, and a document. In one example, an application server can receive the content, determine that the content is associated with the user, and send a body of text from the content to the checklist system.

The checklist system can store task templates that can be used to create action-based tasks based on a body of text. A task templates can include various components that can aid the user in completing a task. For example, the task template can include a Uniform Resource Indicator (“URI”) component, a description component, and a completion component. The URI component can dictate an action that the user device performs when the user selects an action link of a task. In one example, the URI component can be a Uniform Resource Locator (“URL”) that causes the user device to launch a web page associated with the task. In another example, the URI component can be a “mailto” URI that invokes a local email agent on the user device to open an email application and load an email draft. The description component can provide a description of the task that the user needs to complete. In one example, the task description can be a hyperlink that displays text from the task description and executes the URI component action when selected. The completion component can provide a description of criteria for completing the task. In one example, a created task can include a completion button that the user can select after successfully completing the task.

In an example, the task template components can include static portions and one or more entity placeholders. The static portions can include portions that are the same for every task created from that specific template. The entity placeholders can be placeholders that can be replaced by text specific to the task being created. As an example, a task can call for the user to perform an action on a trouble ticket. The URI component for the associated template can include a static portion that is the portion of a trouble ticket URL that is the same for every trouble ticket, and it can include an entity placeholder that represents the ticket number in the proper URL format. The checklist system can identify an entity value in the text body that corresponds to an identifier (“ID”) of the ticket. The checklist system can map the entity value to the corresponding entity placeholder and replace the entity placeholder with the entity value. When the user selects the corresponding action link in the task, the user device can launch a web page for the trouble ticket.

In an example, the checklist system can identify the proper template for a task by extracting words from the body of text that correspond to text in task descriptions of the templates. In one example, the checklist system can use scoring technique to determine whether a task should be created and which template to use. For example, the checklist system can calculate a score that indicates how strong the words from the text body match the task description, and then select the highest scoring template that exceeds a minimum threshold score.

In an example, the checklist system can identify entity values to insert into the task template by parsing utterances using example utterances provided in the task template. Utterances can include written words and phrases that the checklist system can use to parse text to the components of the task template. Parsing the text can include separating the text body into more easily processed components, analyzing the language syntax, and attaching tags that define each text component. The checklist system can compare the parsed text to utterance examples to identify an entity value. The utterance example in the task template can identify an entity name that the entity value corresponds to. The checklist system can replace all entity placeholders in the task template associated with the entity name with the entity value. The checklist system an create task that includes the replaced values. In one example, the task can be a data file, such as a configuration file, that includes configuration settings from the task template with the replaced entity values.

In an example, the checklist system can add all tasks identified in the body of text to a checklist. The checklist system can then send the checklist to the user device. In one example, the checklist system can send the checklist to another device, such as a server for device services, which can in turn send the checklist system to the user device.

In an example, after the user completes a task, the user can mark a completion button associated with the task, such as a checkbox. The user device can notify the checklist system, and the checklist system can notify the user that requested the task.

In an example, the task template components can be customizable using a graphical user interface (“GUI”) provided by the checklist system. The GUI can be accessible by an administrator (“admin”) user or other type of user with proper access. The admin user can configure an action type for the URI component and provide input for the URI component, description component, and completion component. This can include designating key placeholder locations. The admin user can also provide examples of utterances that can be used to identify entity values. In one example, the checklist system can train a machine learning (“ML”) model to identify the correct entity value using the utterances provided in the task template.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is an illustration of an example system for creating tasks for an action-based checklist.

FIG. 2A is an illustration of an example task template for creating tasks for an action-based checklist.

FIG. 2B is an illustration of an example task template for creating tasks for an action-based checklist

FIG. 3 is a flowchart of an example method for creating a task template for an action-based checklist.

FIG. 4 is a flowchart of an example method for creating tasks for an action-based checklist t.

FIG. 5 is a sequence diagram of an example method for creating tasks for an action-based checklist.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

Systems and methods are described for creating tasks for an action-based checklist. In an example, a checklist system can receive a body of text, such as text from an email, calendar invite, or document. The checklist system can extract words in the text body that correspond to a task description component of stored task templates. Based on the extracted words, the checklist system can identify an applicable task template. The checklist system can parse utterances in the text body and identify an entity value based on example utterances provided in the task template. The checklist system can insert the entity value into placeholders in the task template and generate task from the task template. The checklist system can add the task to a checklist that is provided to a user device.

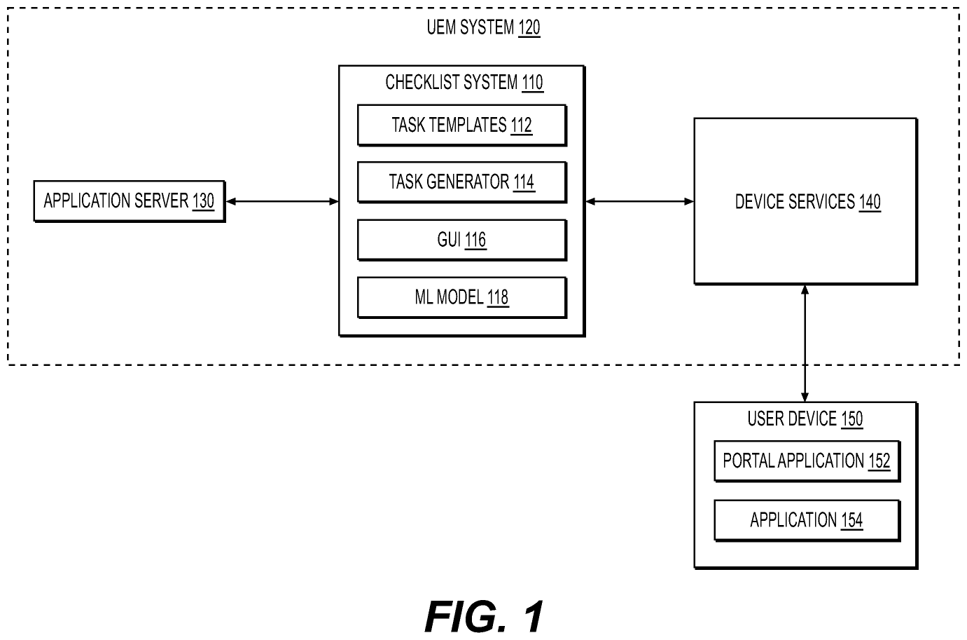

FIG. 1 is an illustration of an example system for creating tasks for an action-based checklist. A checklist system 110 can be provided that is responsible for generating tasks from content associated with a user and the tasks to a checklist for a user. In one example, the checklist system 110 can be a single server or a group of servers, including multiple servers implemented virtually across multiple computing platforms. In another example, the checklist system 110 can be a cloud-based service. In still another example, the checklist system 110 can be installed as an application or service on another device, such as the application server 130, the device services 140, or the user device 150. The checklist system 110 can be part of a Unified Endpoint Management (“UEM”) system 120. The UEM system 120 can allow an enterprise to manage work-related applications and data on enrolled user devices 150. Users can enroll their own devices, such as cell phones, tablets, or laptops. Enrollment can include installing a portal application 152 and other resources on the user device 150. The user device 150 can be one or more processor-based devices, such as a personal computer, tablet, or cell phone.

In an example, device services 140 or another service in the UEM system 120 can manage enrolled user devices 150 by sending management instructions to the portal application 152. The device services 140 can include a service on one or more servers, including multiple servers implemented virtually across multiple computing platforms. The portal application 152 can be a stand-alone application, part of an enterprise application, or part of an operating system of the enrolled devices 150. In an example, the portal application 152 can include a management component that executes on the enrolled device 150. The management component can ensure that the enrolled device 150 is up to date with compliance and security settings prior to the enrolled device 150 accessing enterprise data and resources. In another example, the management component can be an application or service separate from the portal application 152. The management component can communicate with the device services 140, allowing UEM management of the enrolled device 150 based on compliance and security settings at the device services 140. The management component can enforce compliance at the enrolled device 150, such as by wiping enterprise data when compliance standards are not met. Example compliance standards can include ensuring a device is not jailbroken, that particular encryption standards are used in enterprise data transmission, that the device does not have certain blacklisted applications installed or running, and that the device is located within a geofenced area when accessing certain enterprise resources. In one example, the enrolled device 150 can access enterprise or UEM resources through the device services 150.

The UEM system 120 can include one or more application servers 130 that host UEM applications. As some examples, the application server 130 can be a server for an email application, a video conference application, or a support ticket application. In one example, the user device 150 can include an application 154 that is associated with the application server 130. As an example, the application server 130 can be an email server, and the application 154 can be an email application that communicates with the email server to send and receive emails for the user's email account. In one example, the application 154 can be a managed application that allows the enterprise to control access and functionality of the application through UEM system 120. In another example, the application 154 can be a web or cloud-based application that the user can access through a web browser.

Many examples described herein refer to the application server 130 as an email server, and the application 154 as an email application. However, these are merely examples, and the application server 130 can be a server for any application that receives or manages content associated with users. Additionally, although the application server 130, checklist system 110, device services 140, and user device 150 are described as being part of the UEM system 120, that is merely one example system for providing an action-based checklist. For example, the methods described herein can be performed by the components described in FIG. 1 without including the UEM system 120.

In an example, the application server 130 can be configured to identify content associated with users of the UEM system 120. As some examples, the application server 130 can identify an email addressed to the user, identify a video web conference the user is invited to, or identify a trouble ticket assigned to the user. The application server 130 can extract a body of text from the content and send the body of text to the checklist system 110.

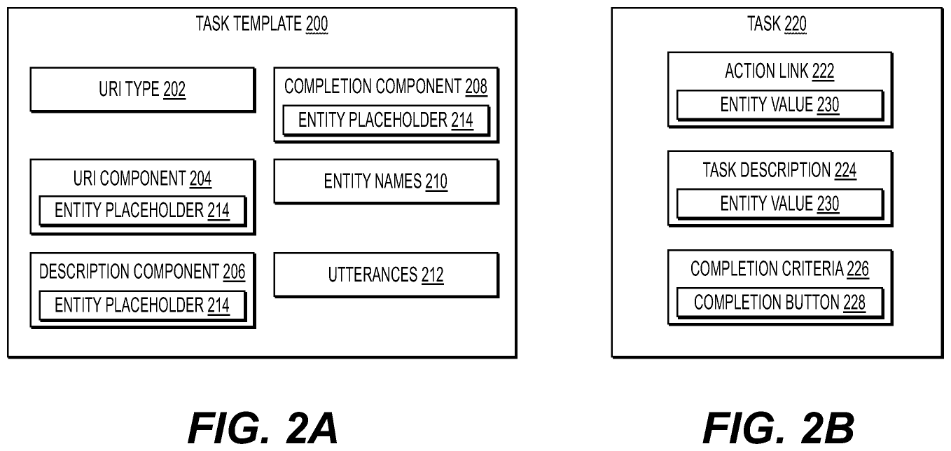

The checklist system 110 can analyze the text to determine where the text includes any action-based items for which a task can be created. A task generator 114 of the checklist system 110 can analyze the text to determine if one or more portions of the text body matches to a stored task template 112. Task templates 112 are described in more detail regarding FIG. 2 below. In one example, the task generator 114 can apply one or more ML models 118 to match portions of the text body to the text templates 112 and insert text from the text body into portions of the text templates 112.

In an example, the checklist system 110 can create tasks for multiple action-based items in the content and combine them into a checklist. In one example, a checklist can include all the tasks created from a single content source, such as a single email or email chain, a single instant message, or a single message conversation. The checklist system 110 can then send the checklist to the device services 140, and the device services 140 can provide the checklist to the user device 150.

The user device 150 can display the checklist for the user. In one example, the user device 150 can display the checklist in the portal application 152. For example, the portal application 152 can include a GUI with a window or page where the user can view and interact with the checklist. Alternatively, the user device 150 can display the checklist in the application 154. For example, the application 154 can be an email application that converts text in the text body to an actionable checklist or displays the checklist in a separate window. In one example, the checklist can include all the tasks created from a content course. For example, the checklist can include all tasks created from an email sent to the user. The user can interact with each task independently.

In an example, the user can modify the checklist. For example, the checklist can allow the user to add, remove, or modify tasks. As an example, the user may know additional steps to take in completing a task, and the checklist can allow the user to add those steps. In one example, the checklist can allow the user to remove a task that was created in error. In such an example, the checklist system 110 can retrain the ML model 118 based on the user removing the task. In another example, the user can modify a task when, for example, a task contains an error.

In an example, the checklist can be made available for any user device associated with the user. For example, the user can have multiple user devices enrolled in the UEM system 120, such as a cell phone, a tablet, and a computer. The device services 140 can make the checklist available to all user's devices enrolled with the user's profile. In one example, the user can access the checklist using the portal application 152 on any of his or her enrolled devices. In another example, the checklist can be made available through a web application so that the user can access the checklist through a non-enrolled user device.

In an example, the user can select a completion button on a task after performing an associated action. The button can be a conventional program button, and may be represented by any desired shape, size, or icon. The user device 150 can be configured to notify the device services 140 can when the user marks a task complete. In one example, the device services 140 can notify another user of the task completion. For example, where a first user sends an email to a second user that includes tasks to be performed, the device services 140 can notify the second user after the first user indicates that the task is complete.

In an example, the checklist system 110 can include a GUI 116 that allows an admin user with access rights to create task templates 112. For example, the checklist system 110 can make the GUI 116 available as a cloud service or a web application. The task templates 112 can be used to create tasks from content sent to a user. Examples of content can include a body of text from an email, a calendar invite, a document draft, user-created notes, a support ticket, and the like.

FIGS. 2A and 2B are illustrations of an example task template 200 and an example created task 220, respectively, and will be described jointly. In one example, the task template 200 can correspond to a task template 112 described above regarding FIG. 1, and the task templates 112, 200 are referred to interchangeably throughout. The task template 200 can be used to create the task 220 that includes three primary components: an action link 222, a task description 224, and completion criteria 226. The action link 222 can be a URI that the user can select to trigger a corresponding action, such a launching a web page or opening the application 154. The task description 224 can describe the action that the action link performs. The completion criteria 226 can describe what the user must do before completing the task.

In an example, the task template 200 can be created by an admin user using the GUI 116. The GUI 116 can provide options for the admin user to customize the various components of the task template 200 that are described below. In an example, the GUI 116 can include an input field for each component of the task template 200.

The task template 200 can include a URI component 204 dictates that action that occurs when the user selects the action link 222. As an example, the URI component 204 can be a Hypertext Transfer Protocol (“HTTP”) or Hypertext Transfer Protocol Secure (“HTTPS”) URL that causes the user device 150 to launch a web page. In another example, the URI component 204 can be a “mailto” URI that invokes a local email agent on the user device 150 to open the application 154 and load an email draft.

In an example, the class of the URI component 204 (e.g., URL and mailto) can be determined by a URI type 202. In one example, the URI type 202 can be selected by the admin user. For example, the admin user can select the URI type 202 from a list, such as in a prepopulated drop-down menu. The admin user can then enter the URI for the task template 200 into a field corresponding to the URI component 204. In one example, the GUI 116 can be configured to verify that the format of the URI provided by the admin user matches the class of URI indicated by the selected URI type 202. For example, the GUI 116 can display an error and prevent the admin user from saving the task template 200 is the admin user selected a mailto meta task but entered a URL into the URI component 204 field.

In an example, the URI component 204 can include a static portion and an entity placeholder 214. The static portion can be a portion of the URI component 204 that is the same for every task 220 created from the task template 200, and the entity placeholder 214 can be a placeholder for an entity value 230 extracted from the text body.

The following example will be used to help describe the URI component 204 as well as other components of the task template 200 described below. In the example, an admin user is creating a task template 200 for actions requested of a user of the user device 150 to perform an action on a specific ticket in the ticket tracking system JIRA. The admin user's organization can use a web-based version of JIRA, so the admin user selects a URL URI type 202. In the URI component 204, the admin user enters a static subcomponent that corresponds to the portion of the JIRA URL that will be static regardless of the ticket the user needs to work on. After the static, the admin user can enter an entity name 210. The admin user can enter entity placeholders 214 corresponding to the entity name 210 into the URI component 204. The entity placeholder 214 can be replaced with a corresponding entity value 230 extracted from the text body when the checklist system 110 creates the task 220. As an example, URLs for tickets in JIRA can follow the format of “https://jira.eng.client.com/browse/[ticket name]” where [ticket name” corresponds to the name or number of the JIRA ticket. When creating the task template 200, the admin user can enter “jira_ticket_name” as an entity name 210. The admin user can also enter https://jira.eng.client.com/browse/{jira_ticket_name} into the URI component 204 where “{jira_ticket_name}” is an entity placeholder 214 corresponding to the entity name 210 “jira_ticket_name.” When creating a task 220, the checklist system 110 can identify the number of a JIRA ticket as the entity value 230 for the entity name 210 “jira_ticket_name.” The checklist system 110 can then replace “{jira_ticket_name}” in the URI component 204 with the JIRA ticket number. As an example, where the checklist system 110 creates a task for a JIRA ticket with the name “Project-5678”, the checklist system 110 can identify “Project-5678” as the entity value 230 that corresponds to the entity name 210. The checklist system 110 can then replace the entity placeholder 214 in the URI component 204 so that the URI component 204 is “https://jira.eng.client.com/browse/Project-5678.” This will cause the user device 150 to launch a web page of the JIRA ticket named “Project-5678” when the user selects the action link 222.

The checklist system 110 can include a description component 206 and a completion component 208. The description component 206 can include text that describes the task and the completion component 208 can include text that describes criteria for completing the task. In one example, the admin user can input the text. The text in the description component 206 can be displayed as the task description 224 in the created task 220, and the completion component 208 can be displayed as the completion criteria 226. In one example, the task description 224 can be a hyperlink for the action link 222 that displays text from the description component 206.

In an example, the description component 206 and completion component 208 can include an entity placeholder 214. The checklist system 110 can replace the entity placeholders 214 in the description component 206 and completion component 208 with an extracted entity value 230 just as with the URI component 204 described above. As an example, where the description component 206 reads “Open JIRA issue {jira_ticket_name},” the checklist system can replace this instance of “{jira_ticket_name}” with the entity value 230 “Project-5678” so that the task description 224 displays “Open JIRA issue Project-5678.”

Although the examples above describe the URI component 204 and the description component 206 using the same entity name 210, different entity names 210 can be used. For example, the URI component 204 can include an entity placeholder 214 for a first entity name 210, the description component 206 can include an entity placeholder 214 for a second entity name 210, and the completion component 208 can include an entity placeholder 214 for a third entity name 210. Each of the components 204, 206, 208 can also include multiple entity placeholders 214. In examples where the template includes multiple entity names 210, the checklist system 110 can extract an entity value 230 for each entity name 210 and map the entity values 230 to their corresponding entity placeholders 214. As an example, the user can receive an email that includes the task “Send Release Mail to EUC Release Team.” The checklist system 110 can identify an email-based task template for this task. When parsing the text, the checklist system 110 can identify multiple entity values. One entity value 230 can relate to the “Release Mail.” The checklist system 110 can determine what “Release Mail” refers to and create an entity value 230 for it. For example, “Release Mail” can correspond to a template email for a release related to the JIRA ticket, “Project-5678.” In such an example, the checklist system can assign an entity value 230 that corresponds to the template email. In one example, the template email can include entity placeholders 214 for related fields, such as the JIRA ticket ID and the names of the email recipients. The checklist system 210 can determine these entity values 210 based on context in the body of text.

In an example, the checklist system 210 can identify the “EUC Release Team” as the intended recipient of the email task. The checklist system 210 can retrieve one or more associated email addresses and designate those email addresses as an entity value 210 that corresponds to an entity placeholder 214 in the URI component 204 related to email recipients. In another example, task template 200 can include an entity placeholder 214 for the name of the email recipient. The checklist system 110 can retrieve the name of the user (or organization) associated with the email address, and that name can be an entity value 230 for another entity placeholder 214.

In an example, the “Release Mail” text can refer to a data file. If the checklist system 110 makes this determination, the checklist system 110 can attempt to retrieve the data file and add it to the email draft as an attachment.

The checklist system 110 can therefore identify multiple entity values from a single utterance or word in the body of text. In an example, this can be used to identify the most appropriate task template 200. For example, the checklist system 110 can store multiple related email-based task templates 200 that vary based on the entity values 230 that the checklist system 110 can extract from the body of text. The checklist system 110 can use the task template 200 that includes entity names 210 corresponding to all the extracted entity values 230. As an example, a first task template 200 can include the name of the email recipient while a second task template 200 does not. The two task templates 200 can be otherwise identical. If, for a task, the checklist system 110 can identify the name of the email recipient, then the checklist system 110 can use the first task template 200. If not, the checklist system 110 can use the second task template 200. In one example, the checklist system 110 can omit portions of the task template 200 where a certain entity value 230 cannot be identified.

In one example, the task generator 114 can be configured to recognize text in a particular format as an entity placeholder 214 that calls for an entity value 230. The examples herein describe using braces ({ }) to indicate a call for an entity value 230, but any format can be used, such by using angle brackets (< >). In one example, the GUI 116 can provide a button or menu that includes any entity names 210 provided by the admin user, and the admin user can simply select the button or choose the entity name 210 from the menu to populate the entity name 210 into the corresponding component field. This can help prevent errors where the entity name 210 does not populate correctly due to typos, for example.

In an example, tasks can be grouped together based on matching entity values 230, such as tasks associated with the same project. Using the example above, the checklist system 110 can group or link tasks that share the entity value “Project-5678” when creating the checklist. The checklist system 110 can display related tasks in the checklist in a way that indicates their relation. For example, the checklist system 110 can create a section header that reads “JIRA Ticket Project-5678 Tasks” and position the related tasks underneath as a bulleted list. In one example, GUI 116 can include a public option that lets the admin user choose whether an entity name 210 can be shared among different tasks 220 created from the same content. For example, if a task template 200 has the public option disabled, any tasks created from the task template 200 will not be linked to other tasks even when they share a same entity value 230.

In an example, the task template 200 can include utterances 212. The utterances 212 can include words and phrases provided by the admin user that can be used to parse text in a text body to the task template 200. Some examples of utterances 212 can include “run a round of sanity check,” “send an email,” or “organize a meeting.” Parsing the text can include separating the text body into more easily processed components, analyzing the language syntax, and attaching tags that define each text component. The checklist system 110 can parse the text body and, using example utterances provided in the template 200, identify entity values 230 that correspond to the entity names 210. In one example, the checklist system 110 can use the utterance list train the ML model 118 to parse the text and extract the entity values 230.

In an example, the checklist system 110 can identify entity values 230 based on the format of the utterance 212. For example, the utterance 212 can include an example word or phrase, an example entity value, and a designated entity name. As an example, the utterance 212 can follow the format of “example_text [example_value] {entity: entity_name, value: example_entity_value}.” In this example, the example_text can correspond to example text that the checklist system 110 can compare parsed text to, and the example text can be identified as any text not inside of braces or brackets ([ ]). The example_value corresponds to an example entity value 230 and can be identified as text inside of brackets. The entity_name corresponds to an example entity name 210 and can be identified as the text after “entity:” within the braces. The example_entity_value corresponds to an example_entity_value 230 and can be identified as the text after “value:” inside the braces. The checklist system 110 can compare parsed text from the content to the example_text and identify a value corresponding to the example_value. The checklist system 110 can use the example_value to determine an example_entity_value, which can then be used to replace entity placeholders 214 that correspond to the entity_name.

To help explain this, we can use a template 200 with the following example utterance 212: “send an email to [John] {entity: email_recipient, value: john@company.com}.” A user can receive an email to includes the text “please send an email to Michael about Project_5678.” The checklist system 110 can parse this text and “please send an email to” to the example text “send an email to” in the utterance 212. The checklist system 110 can correspond “Michael” with “[John]” and create an entity value based on the format from the utterance 212. For example, the checklist system 110 can input “michael@company.com” as the entity value 230 for the entity name 210 “email_recipient.” The checklist system 110 can then insert “michael@company.com” into all entity placeholders 214 that correspond to the entity name 210 “email_recipient.” In one example, instead of replacing the value “john” in the email address with “michael,” the checklist system 210 can identify a user profile that corresponds to “Michael,” retrieve the email address of the user profile, and insert the email address of the user profile as the entity value 230. In one example, the checklist system 110 can identify the user profile and the email address by matching “Michael” to a contact in the user's address book. The resulting task 220 can cause the user device 110 to open an email draft with the addressee field prepopulated with “michael@company.com.”

Furthering this example, the template 200 can include another utterance 212 that reads “send an email to John about [Project_1234] {entity: email_subject, value: re JIRA ticket Project_1234}.” For this utterance 212, the checklist system 110 can be configured to use “John” only as part of the example_text. In one example, the checklist system 110 can be configured to ignore a proper name like “John.” Using the same technique described above, the checklist system 110 can insert “Project_5678” into the entity value 230 so that it reads “re JIRA ticket Project_5678,” and that entity value 230 can be inserted into the entity placeholders 214 that correspond to the entity name 120 “email_subject.” By combining these utterances 212, the email draft described above that the user device 110 opens can also have the subject line prepopulated with the text “re JIRA ticket Project_5678.”

In an example, multiple tasks 220 can be created from a single action-item identified in content. For example, the checklist system can create a checklist with multiple tasks 220 based on a single utterance identified in the content. As an example, an email can be sent to the user that includes the text “Please prepare Project-1234 to reach Release Readiness Status.” “Releasing Readiness Status” can be a process that includes multiple required actions by the user. The admin can provide the text “Release Readiness Status” as an utterance 212 that triggers the checklist system 110 to create a checklist with a series of associated tasks 220. The checklist system 110 can create the multi-task checklist based on the single utterance rather than requiring that each task to be individually mentioned in the email. Using this feature, a user can send an entire checklist to another user by merely including the corresponding utterance 212 in a message to the other user.

In an alternative example, rather than a single utterance 212 triggering the creation multiple tasks 220, the GUI 116 can allow the admin to configure task templates 200 to trigger the creation of additional tasks using other task templates 200. In one example, the admin user can identify one or more additional task templates 200, which can enable a flag in the original task template 200 that causes the checklist system 110 create additional tasks 220 from the task templates 200 identified by the admin. In another example, the entity values 230 from the first task template 200 can transfer to the additional task templates 220. Using the previous example above, “Release Readiness Status” can trigger the checklist system 110 to create a task based on a first task template. A flag for creating additional tasks can be enabled in the first task template. The checklist system 110 can retrieve the task templates that are identified in the first task template. The checklist system 110 can also transfer any entity values 230 from the first task template that correspond to matching entity placeholders 214 in the additional tasks. In one example, the checklist system 110 can create a checklist that includes all the associated tasks and send the checklist to the device services 140 for distribution to the user device 150.

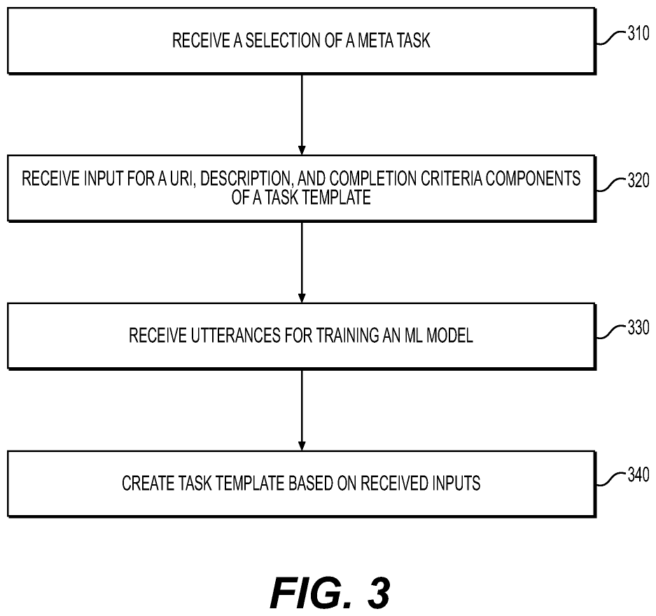

FIG. 3 is a flowchart of an example method for creating an action-based task template. At stage 310, the checklist system 110 can receive a selection of a URI type 202. For example, an admin user can select the URI type 202 from a list in the GUI 116, such as in a prepopulated drop-down menu. In one example, the URI type selection can affect the type of acceptable input for other components. For example, a selection of a URL for the URI type 202 can cause the checklist system 110 to only accept input for the URI component in the form of a URL.

At stage 320, the checklist system 110 can receive input for the URI component 204, the description component 206, and the completion component 208. The input can include a static portion and an entity placeholder 214. The static portion can be a portion of the URI component 204 that is the same for every task created from the task template 200, and the entity placeholder 214 can call for an entity value 230 that the checklist system 110 provides. The entity value 230 can vary from task to task depending on the text in the text body.

At stage 330, the checklist system 110 can receive utterances for training the ML model 118. In one example, the utterances can be written words and phrases that the checklist system 110 can use to parse text to the components of the task template 200. For example, the admin user can enter various words and phrases that may be used when asking a user to perform a certain action associated with the task. The checklist system 110 can train the ML model 118 to parse the utterances to the task template 200 and extract its entity values 214.

At stage 340, the checklist system 110 can create a task template 200 based on the received inputs. In an example, the checklist system 110 can save the task template 200 as a data file, such as an extensible markup language (“XML”) file or a YAML Ain′t Markup Language (“YAML”) file. The following is an example task template 200 YAML file for the JIRA ticket example described previously herein:

```
Task template:
  - jira_issue
    −> uri_type: https
    −> uri: https://jira.eng.client.com/browse/ {jira_ticket_name}.
    −> description: Open jira issue {jira_ticket_name}
    −> completion_criteria: Make sanity checking comment in Jira ticket {jira_ticket_name}
  Entities:
```

| | |
|---|---|
| - | jira_ticket_name |
| | −> public: false |

Utterances:

| | |
|---|---|
| - | name: jira_issue |
| | Examples: - run round of sanity check for [Project-1234] {entity: jira_ticket_name, value: |
| | Project_1234} |

The example YAML file above includes three sections: a template configuration section, an “Entities” sections, and an “Utterances” section. The template configuration section is the portion under the template name, “jira_issue.” In the configuration section, “uri_type” corresponds to the URI type 202, “uri” corresponds to the URI component 204, “description” corresponds to the description component 206, “completion criteria” corresponds to the completion component 208.

The “Entities” section can include one or more entity names 210. The example file above only includes one entity name 210, which is named “jira_ticket_name.” The entity name 210 is included inside braces (indicated by {jira_ticket_name}) in the “uri,” “description,” and “completion criteria” components as an entity placeholder 214. Once the actual entity value 230 corresponding to the “jira_ticket_name” is identified, the corresponding entity placeholders 214 can be replaced with the entity value 230. This is described in more detail later herein. Although the example file above includes only one entity 210, task template files 200 can include multiple entity names 210.

In an example, the entity names 210 can include a public option, indicated by “public:” above, that indicates where the entity name 210 can be shared among different tasks 220 coming from different task templates 200 in a checklist. For example, the entity name 210 can be shared if the value of the public option is “true,” but not if the value is “false.” In one example, this value can be set by an admin user. This feature can be particularly useful when multiple associated tasks are added to the same checklist. As an example, a supervisor can send an email to a user asking the user to perform multiple tasks related to a single JIRA ticket. The checklist system 110 can determine that at least two of the tasks are related to the same JIRA ticket. In one example, the checklist system 110 can combine the two tasks or link them together. For example, the checklist system 110 can create a single task 220 with an URI component 204 that launches a web page corresponding to the JIRA ticket. The single task 220 can combine the descriptions 206 and completion criteria 208 of the two tasks and include a separate completion button 228 for each task 220.

The “Utterances” section corresponds to the utterances 212. Each utterance 212 can include a task name and examples. The task name can identify the template that the utterance corresponds to. For example, the name field in the example file above is “jira_issue,” which corresponds to the template configuration under the same name. This feature can be especially useful in examples where the utter list 212 is not included as part of the task template 200. For example, the utterance list 212 can be stored separately from the task templates 200. The checklist system 110 can identify utterances in a text body and map the utterance to a task template 200 by matching the utterance name field to the corresponding template configuration name.

In an example, an admin user can provide examples utterances 212. For example, the example file above includes “run round of sanity check for [Project-1234] {entity: jira_ticket_name, value: Project_1234}.” As will be described in more detail below, the checklist system 110 can identify text in a text body that matches “run round of sanity check for.” The checklist system 110 can also be trained to identify text similar to the example text or phrases in the text body that may indicate the same meaning. The utterance 212 example can also include an example entity name 210 using a predetermined format. For example, the example entity name in the example file above, “Project_1234,” is inside brackets (“[ ]”). The utterance 212 example then indicates which entity placeholders 214 in the task template 200 the entity name 210 corresponds to. For example, in the example file above, when creating a task 220 the checklist system 110 will identify any text similar to, or similar in meaning to, “run round of sanity check for,” identify a corresponding entity value 230 and its corresponding entity name 210, and insert the entity value 230 into the “jira_ticket_name” field in the task template 200.

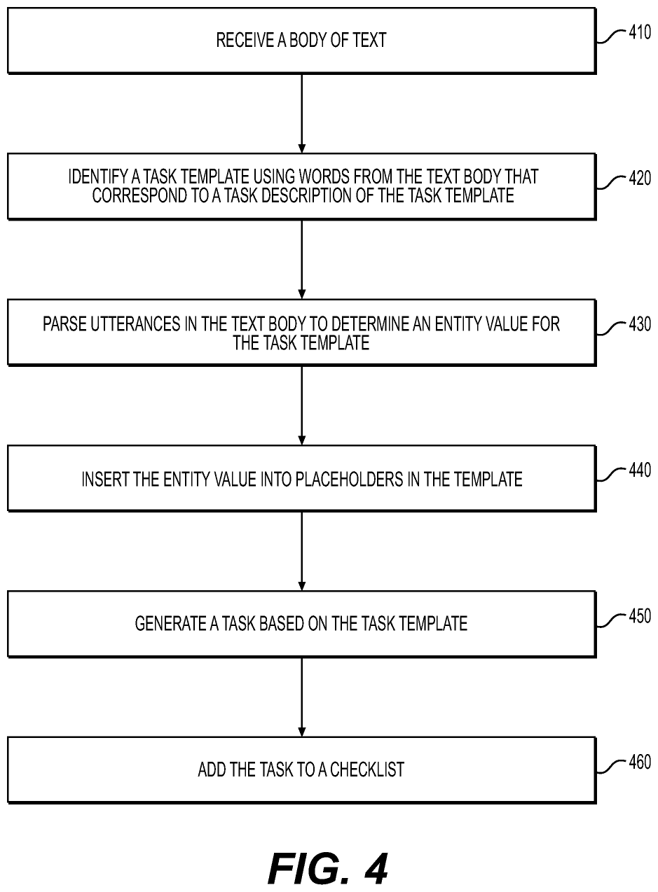

FIG. 4 is a flowchart of an example method for creating tasks for an action-based checklist. At stage 410, the checklist system 110 can receive a body of text. The text can come from content associated with the user of the user device 150. As some examples, the text can come from an email, a calendar invite, a document draft, user-created notes, a support ticket, and the like. In an example, the application server 130 can extract the text from the content and send the text to the checklist system 110. In another example, the application server 130 can send information identifying a user associated with the text. For example, if the body is an email, the application server 130 can send the recipient's email address or an associated user ID. In another example, the application server 130 can also send information related to the sender, such as the sender's email address or user ID. In an example, the sender's information can be used to notify the sender when the recipient user completes a requested task. Alternatively, the management component or device services 140 can collect the text and send it to the checklist system 110 in an example.

At stage 420, the checklist system 110 can identify one or more applicable task templates 200 using words from the text body that correspond to the description component 206 of the task template 200. For example, the checklist system 110 can compare words and phrases in the text body to words and phrases in the description component 206 of the task templates 200 stored in the checklist system and identify the task template 200 with closest match. The matching task template 200 can be determined using one or a combination of various language processing techniques, such as a heuristic rule method like regular expression (“regex”), natural language processing (“NLP”), and the ML model 118. In one example, the ML model 118 can be trained using words and phrases provided by an admin user when creating the task template 200. In another example, users can provide input indicating whether a checklist task 220 was properly created based on the text body, and the checklist system 110 can retrain the ML model 118 when a task 220 is improperly created.

In one example, the checklist system 110 can calculate a likeness score that indicates the strength of the comparison between a portion of the text body and the description components 206. The checklist system 110 can select the task template 200 whose description component 206 scored the highest. In another example, the checklist system 110 can require a minimum threshold likeness score. As an example, where the highest scoring template 200 scores a 2 out of 10, this may indicate that there is no task being requested from the user. The checklist system 110 can require a higher score, such as a 7 out of 10. In instances where at least one portion of the text meets or exceeds the minimum threshold score, the checklist system 110 can select the template 200 with the highest score for creating a corresponding task.

In an example, a single word or phrase in the text body can trigger the checklist system 110 to create multiple tasks 220. In one example, the checklist system 110 can create multiple tasks 220 when a certain word or phrase matches to the description component 206 of multiple task templates 200. This determination can also be made based on matching utterances 212, in an example. In another example, the creating a task 220 from one task 220 can trigger the creation of additional tasks 220 from other task templates 200. For example, the text can match to a first task template that identifies one or more other tasks that should be created. The checklist system 110 can retrieve the task templates identified in the first task template and create additional tasks using the entity values 230 used in the first task template. For example, the checklist system 110 can transfer any entity values 230 from the first task template that correspond to matching entity placeholders 214 in the additional tasks.

At stage 430, the checklist system 110 can parse utterances in the text body to identify an entity value 230 for the task template 200. For example, the checklist system 110 can compare examples utterances 212 to the text body or a portion of the text body relevant to the task 220 being created. The checklist system 110 can match a portion of the text body to an example utterance 212 and extract an entity value 230. Matching the text and utterances can include identifying any text similar to, or similar in meaning to, text in the example utterance. The example utterance can indicate which entity name 210 the entity value 230 corresponds to. In one example, the comparison and extraction can be performed by applying an ML model 118. The ML model 118 can be the same or a different ML model from the ML model 118 described in stage 420 above. The ML model 118 in this stage can be trained to identify entity values 214 using example utterances provided by the admin user, as an example.

Using the YAML example file described previously, an example utterance 212 can be “run round of sanity check for [Project-1234] {entity: jira_ticket_name, value: Project_1234}.” The text body can include a portion that reads “Please run a round of sanity (PROJ-5678).” The checklist system 110 can determine that “Please run a round of sanity” corresponds to the example “run round of sanity check.” The checklist system 110 can then identify the entity value 230 as “PROJ-5678” based on its location in the text body next to the corresponding text, the format of the text, and any other relevant factors.

At stage 440, the checklist system 110 can insert entity values 230 from the parsed utterances into their corresponding entity placeholders 214 in the task template 200. For example, as described previously, the components of the task template 200 (the URI component 204, the description component 206, and the completion component 208) can include an entity placeholder 214 that the entity values 230 map to. The checklist system 110 can insert each extracted entity value 230 to its corresponding entity placeholder 214.

Continuing the example above, based on the utterances 212, the checklist system 110 can associated the extracted entity value 230 “(PROJ-5678)” with the entity name 210 “jira_ticket_name.” The checklist system 110 can then insert the extracted entity value 230 into all entity placeholders 214 with the entity name 210 “{jira_ticket_name}.” For example, the URI component 206 “uri: https://jira.eng.client.com/browse/{jira_ticket_name}” becomes “uri: https://jira.eng.client.com/browse/Project-5678,” and so on. The checklist system 110 can do this for each entity value 230 extracted from the text body.

At stage 450, the checklist system 110 can generate a task 220 based on the task template 200. In one example, this can include generating a data or configuration file. As an example, such a file can include the task configuration portion of the task template 200 described in the YAML file example. The following is an example of a file for a task 220 from that example where the entity 210 value is “Project-5678.”

```
Task:
  - jira_issue
    −> uri_type: https
    −> uri: https://jira.eng.client.com/browse/Project-5678
    −> description: Open Jira issue Project-5678
    −> completion_criteria: Make sanity checking comment in Jira ticket Project-5678
```

When the task file above is displayed on the user device 150, the “uri_type” field dictates that the action link 222 be a web link, and the corresponding URL will be “https://jira.eng.client.com/browse/Project-5678.” The user device 150 can display the action link 222 as selectable text corresponding to the “description” field. The user device 150 would therefore display “Open Jira issue Project-5678” as a URL hyperlink for the action link 222. The user device 150 can display the completion criteria 226 as the text “Make sanity checking comment in Jira ticket Project-5678” along with the completion button 228 that the user can select after completing the task.

At stage 460, the checklist system 110 can add the task to a checklist. The checklist system 110 can add one or multiple tasks 220 created from the text body. In one example, the checklist system 110 can add the data or settings for each task 220 to a single file. Alternatively, the checklist can include individual files for each task. In one example, related tasks 220 can be grouped in the checklist. For example, the checklist can include a header for a set of related tasks 220 and position the related tasks underneath as a bulleted list. This can help the user identify tasks 220 in a checklist that are closely related or associated with the same request.

In an example, the checklist system 110 can send the checklist to the user device 150. This can include sending the checklist to the portal application 152, and the portal application 152 can manage the checklist at the user device 150. In one example, the portal application 152 can display the checklist in a GUI of the portal application 152. In another example, the portal application 152 can display the checklist in a GUI for another managed application, such as the application 154 that corresponds to the application server 130 where the text body originated from.

In an example, the checklist system 110 can send the checklist to the device services 140, and the device services 140 can manage the checklist at the user device 150 through the portal application 154. For example, the device services 140 can send the checklist to the portal application 154. This can occur during a sync session or as a push notification, as some examples. The device services 140 can store information about the checklist locally, which can include an ID of a user to notify when a task 220 has been marked complete. When the user of the user device 150 marks a task 220 complete, the portal application 152 can notify the device services 140. The device services 140 can record the action, and, in an example, can notify the user that identified for notification. For example, the device services 140 can send a push notification or an email to a user device 150 of the identified user. That user then has the opportunity to verify that the task was indeed completed.

In an example, the user can modify the checklist as appropriate. For example, the user can remove a task that was erroneously created, add a new task that should be included, move a task up or down on the checklist into a more logical order, or reassign a task or an entire checklist to another user. In one example, any changes made by the user can be reported to the checklist system 110, and the checklist system 110 can use the reported changes to retrain the ML model 118.

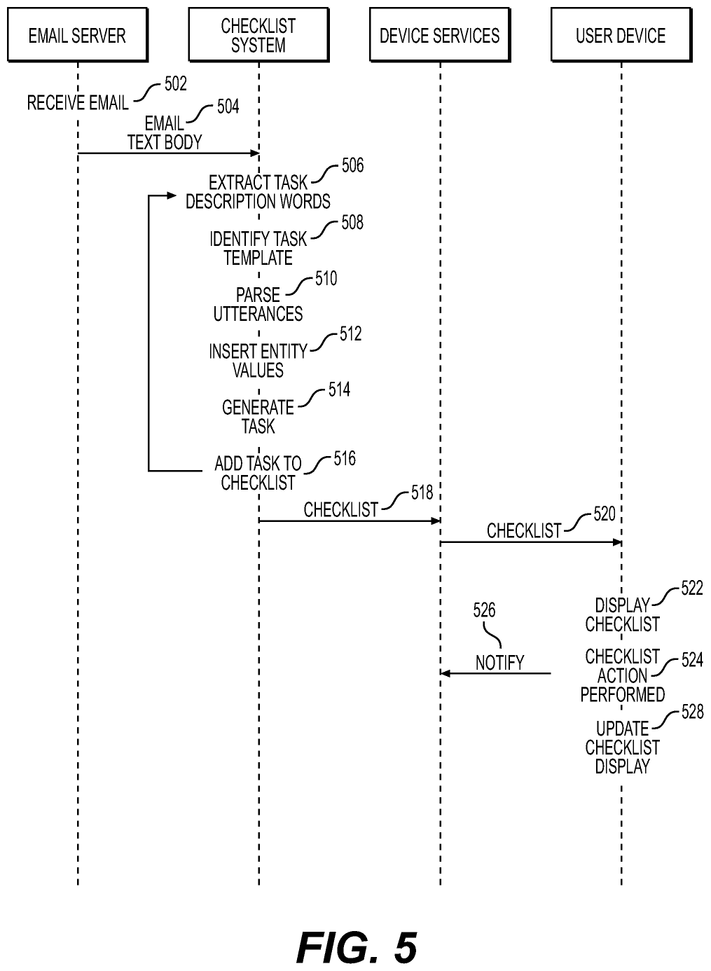

FIG. 5 is a sequence diagram of an example method for creating tasks for an action-based checklist. This example method uses an email received at an email server as an example of content that a task 220 can be created from. The email is merely one example of the type of content that a task 220 can be created from. For example, the email can represent an instant message, a meeting invite, a notification from an application, and other similar types of content. References to an email can therefore also refer to other types of content. Similarly, the email server described below can be any server associated with the content, including the application server 130. References to the email server can also refer to such servers.

At stage 502, email server can receive an email. For example, a user (hereinafter referred to as “the second user”) can send an email to the user of the user device 150 (hereinafter referred to as “the user”) using the user's email address.

At stage 504, email server can send the text body of the email to the checklist system 110. For example, the email server can extract text from the body portion of the email and send the text body to the checklist system 110. In one example, the email server can also send metadata associated with the email, such as the sender email address, the recipient address, and other information related to the email.

In an example, the text body can include text identifying tasks that the second user would like the user to complete. The following will be used forthwith as an example text body from an email:

### Hi John,

Based on our discussions, please perform the below steps to reach Release Readiness Status:
Run a round of sanity (PROJ-5678)
Review Release Documentation.
Tag the release on GITLAB
Organize a meeting with David & Joe
Send Release Mail to EUC Release Team.

### Regards,

### Tony

The example text body above includes five tasks that the second user (“Tony”) would like the user (“John”) to complete. The first task can be “Run a round of sanity (PROJ-5678),” the second task can be “Review Release Documentation,” the third task can be “Tag the release on GITLAB,” the fourth task can be “Organize a meeting with David & Joe,” and the fifth task can be “Send Release Mail to EUC Release Team.” All five tasks can be related to reaching Release Readiness Status for PROJ-5678.

At stage 506, the checklist system 110 can extract task description words from the text body. Task description words can include words and phrases in the description component 206 of task templates 200 stored in the checklist system 110. For example, the checklist system 110 can compare words in the description components 206 to words in the text body and extract any matching words or phrases. In one example, this can be done using one or a combination of various language processing techniques, such as a heuristic rule method like regex, NLP, and a trained ML model 118.

At stage 508, the checklist system 110 can identify a task template based on the extracted task description words. For example, the checklist system 110 can compare the extracted task description words to the description components 206. In one example, the checklist system 110 can calculate a likeness score that indicates the strength of the comparison between a portion of the text body and the description components 206. The checklist system 110 can select the task template 200 whose description component 206 scored the highest. In one example, the checklist system 110 can select a task template 200 only when the highest scoring description component 206 meets a minimum threshold. In the example text body above, the checklist system 110 can identify a task template 200 for each of the five listed tasks. In another example, any task templates that score above a threshold can be selected and used to generate multiple related tasks for a task list.

At stage 510, the checklist system 110 can parse utterances in the text body to identify an entity value 210 for the task template 200. For example, the checklist system 110 can compare examples utterances in the utterance list 212 to the text body or a portion of the text body relevant to the task being created. The checklist system 110 can match a portion of the text body to an example utterance and extract an entity value 210 for the task template 200. Matching the text and utterances can include identifying any text similar to, or similar in meaning to, text in the example utterance. In one example, the comparison and extraction can be performed by applying an ML model 118. The ML model 118 can be the same or a different ML model from the ML model 118 described in stage 506 above. The ML model 118 in this stage can be trained to identify entity values 210 using example utterances provided by an admin user when creating the task template 200, as an example.

In an example, the checklist system 110 can identify where multiple tasks are related and include the same entity value. As an example, using the example described previously regarding FIG. 4 in combination with the example text body above, the checklist system 110 can parse the text “Run a round of sanity (PROJ-5678)” to an example utterance in the utterance list 212 that reads “run round of sanity check for [Project-1234] {entity: jira_ticket_name, value: Project_1234}.” In doing this, the checklist system 110 can determine the entity value 210 for “jira_ticket_name” to be “Project 5678.” The checklist system 110 can apply the ML model 118 to determine that the second and third tasks, “Review Release Documentation” and “Tag the release on GITLAB,” are related to the first task. This can be based on training of the ML model 118 and input provided by users. For example, an admin user can indicate in the GUI 116 of the checklist system 110 that the phrases “run round of sanity check,” “Release Documentation,” and “Tag the release” are typically related and may be associated with the same entity value 210 for the entity “jira_ticket_name.” The checklist system 110 can associate the second and third tasks with the first task in the list based on that input from the admin user. In one example, after the association is made, if the checklist system 110 can identify an entity value 210 for the “jira_ticket_name” entity, it can apply that entity value 210 to all the related tasks. This can be particularly useful where multiple tasks relate to each other, but only one task includes enough information to identify the associated entity value 210 for all the tasks. As an example, the first, second, and third tasks in the example text body above can all relate to the same JIRA ticket identified as “Project-5678,” but only the first task has enough information to identify that JIRA ticket. The checklist system 110 can parse the text in the first task to identify “PROJ-5678” as corresponding to an entity value for “Project-5678” for the “jira_ticket_name” entity. The checklist system 110 can insert “Project-5678” as the value for the “jira_ticket_name” entity in all three related task templates 200. In this way, the output of a first task template can be used as inputs to additional task templates in creating a list of multiple related tasks.

At stage 512, the checklist system 110 can insert entity values from the parsed utterances into components of the task template. This can include replacing entity names in the task templates with entity values. As an example, the task template 200 for the first task can be the task template YAML file described above in FIG. 3. The checklist system 110 can replace all instances of “{jira_ticket_name}” with the value “Project-5678.” The checklist system 110 can do the same for instances of “{jira_ticket_name}” in the task templates 200 of the second and third tasks, even though the task templates 200 of the second and third tasks may be different from the first task. The checklist system 110 can also replace any additional entity value placeholders for task templates 200 of the second and third tasks with their corresponding entity values 230. The checklist system 110 can insert the entity values 210 for the fourth and fifth tasks as well.

As an example, the following illustrates the output for the five tasks that can be created from the example email described above at stage 54:
First Task
   Description: Run a round of sanity (PROJ-5678)
   Action Link: Opens link for JIRA ticket PROJECT-5678 in web browser
   Completion Criteria: Opening of JIRA ticket by assigned user
Second Task
   Description: Review Release Documentation
   Action Link: Opens CONFLUENCE application with the documentation
   Completion Criteria: Opening of CONFLUENCE page by assigned user
Third Task
   Description: Tag the release
   Action Link: Opens link for tagging Release of Project-5678 on GITLAB
   Completion Criteria: Tag the release
Fourth Task
   Description: Organize a Release Go meeting with David & Joe
   Action Link: Opens email client with create meeting screen and automatically adding required members as invitees
   Completion Criteria: Analyzing assigned user's calendar to check if meeting with required members is already created
Fifth Task
   Description: Send Release Mail
   Action Link: Opens email client with compose screen and the relevant Release Team added as addressee
   Completion Criteria: Analyzing assigned user's email sent items to check if the required mail has been sent

For each task in the example output above, the “Description” can correspond to the text displayed in the task description 224 component of the task 220, the “Action Link” can describe that action that the action link 222 triggers, and the “Completion Criteria” can correspond to text displayed in the completion criteria 226 component of the task 220.

At stage 514, the checklist system 110 can generate tasks 220 based on the task templates 200. In one example, this can include generating a data or configuration file for each task 220. As an example, such a file can include the task configuration portion of the task template 200 described in the YAML file above in FIG. 3.

At stage 516, the checklist system 110 can add the tasks 220 to a checklist. The checklist system 110 can add one or multiple tasks 220 created from the text body. In one example, the checklist system 110 can add the data or settings for each task 220 to a single file. Alternatively, the checklist can include individual files for each task.

In one example, the checklist system 110 can combine multiple identified tasks into a single task 220 in the checklist. As an example, the checklist system 110 can merge identified tasks that share a URI component 204 and entity value 230. The result task 220 can include a completion criterium 226 for each merged task. This can help clean up the displaying of the checklist where multiple tasks have the same action link 222. For example, if the user can perform the first three tasks in the example text body above using the same URL, then those three tasks can be combined on the checklist as a single task with a single action button 222, but with three different completion criterium 226 and corresponding completion buttons 228.

The checklist system 110 can continue stages 506 through 516 for additional tasks. This can include using the output of a first task template to identify additional tasks based on the text of stage 504. Additionally, a task template can specify multiple tasks as subtasks for completing a main task identified by the template. All such tasks can be added to the checklist at stage 516.

At stage 518, the checklist system 110 can send the checklist to the device services 140. In an example, the checklist can be sent as one or multiple data files, such as XML or YAML files. In one example, the checklist system 110 can send the checklist using an Application Programming Interface (“API”) call with the device services 140.

At stage 520, the device services 140 can send the checklist to the user device 150. For example, the device services 140 can send the checklist using an HTTP or API call to the portal application 152. At stage 522, the user device 150 can display the checklist. For example, the portal application 152, or alternatively the application 154, can display the checklist in a GUI. In one example, the portal application 152 can cause the user device 150 to generate a notification indicating that the user has a checklist to complete. In one example, the application 154 can be an email application and can display the checklist in conjunction with the email that the checklist is based on.

In one example, the GUI can allow the user to modify the task list. This can include adding or removing tasks. For example, if a user needs to perform a task, such as code a widget prior to completing a task that requires the widget, the user can add that task to the checklist. In one example, added tasks can be considered by an ML algorithm for suggesting future tasks based on a task template. If a similar second task continues to be added by users in association with a generated task, the task template can be updated automatically to include that second task entry.

At stage 524, the user can indicate that a task 220 on the checklist was performed. For example, the user can select the link associated with a task 220, which can cause the user device 150 to perform a related action, such as launching a web page, loading a meeting invite window from an application, or generating a draft email with portions already filled out according to the tasks 220 file. After performing the action, the user can select the completion button 228 corresponding to the completed task 220. In one example, the portal application 152 can monitor event logs on the user device 150 to determine when certain tasks have been completed and automatically select the completion button 228. As an example, where the task calls for the user to send an email to a specified email address, the portal application 152 can communicate with the email application on the user device 150 to detect when an email is sent from the user's email account to the specified email address. For example, the email application can be a managed application and can notify the portal application 152 when such an email is sent.

At stage 526, the user device 150 can notify the device services 140 that the user performed the task. For example, the portal application 152 can send a notification to the device services 140 of the task completion. In one example, this can occur as a push notification. In another example, the notification can occur has part of a scheduled synchronization with the device services 140.

At stage 528, the user device 150 can update the checklist display. In one example, the portal application 152 can remove the completed task 220. In another example, the portal application 152 can change the completion button 228 so that it indicates the task 220 as complete, but the task 220 can remain in the checklist until another event occurs, such as all the tasks associated with that checklist being marked complete.

In an example, the device services 140 can notify the second user after a task is completed. For example, the device services 140 can send a push notification or an email to the second user. The second user then has the opportunity to verify that the task was indeed completed.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for creating tasks for an action-based checklist, comprising:
receiving a body of text;
identifying a task template from a plurality of task templates based on words in the body of text that correspond to a task description in the task template;
parsing an utterance from the body of text using an example utterance in the task template;
identifying an entity value in the parsed utterance based on an example utterance;
inserting the entity value into at least one entity placeholder of the task template;
generating a task based on the task template and the inserted entity value; and
adding the task to a checklist of multiple tasks, wherein the checklist displays on a user device.

2. The method of claim 1, further comprising sending the checklist to a user device associated with the body of text, and wherein the body of text is part of one of an email, a calendar invite, a text document, and a trouble ticket.

3. The method of claim 1, wherein a second task template is used to create a second task for the checklist, the second task template using, as an input, an output from the identified task template.

4. The method of claim 1, wherein task template includes a Uniform Resource Identifier component that causes the user device to perform a predefined action when selected, a description component that displays a description of the predefined action, and a completion criteria component that displays a requirement for completing the task.

5. The method of claim 1, wherein a graphical user interface for the checklist allows a user to add new tasks to the checklist and remove the generated task from the checklist.

6. The method of claim 1, wherein the task template allows the entity value to be shared with additional tasks added to the checklist.

7. The method of claim 1, wherein the task includes a completion button that a user can select, and wherein a selection of the completion button causes a notification to be sent an administrator user device indicating that the task was completed.

8. A non-transitory, computer-readable medium containing instructions that are executed by a hardware-based processor to perform stages for creating tasks for an action-based checklist, the stages comprising:
receiving a body of text;
identifying a task template from a plurality of task templates based on words in the body of text that correspond to a task description in the task template;
parsing an utterance from the body of text using an example utterance in the task template;
identifying an entity value in the parsed utterance based on an example utterance;
inserting the entity value into at least one entity placeholder of the task template;
generating a task based on the task template and the inserted entity value; and
adding the task to a checklist of multiple tasks, wherein the checklist displays on a user device.

9. The non-transitory, computer-readable medium of claim 8, the stages further comprising sending the checklist to a user device associated with the body of text, and wherein the body of text is part of one of an email, a calendar invite, a text document, and a trouble ticket.

10. The non-transitory, computer-readable medium of claim 8, wherein a second task template is used to create a second task for the checklist, the second task template using, as an input, an output from the identified task template.

11. The non-transitory, computer-readable medium of claim 8, wherein task template includes a Uniform Resource Identifier component that causes the user device to perform a predefined action when selected, a description component that displays a description of the predefined action, and a completion criteria component that displays a requirement for completing the task.

12. The non-transitory, computer-readable medium of claim 11, wherein a graphical user interface for the checklist allows a user to add new tasks to the checklist and remove the generated task from the checklist.

13. The non-transitory, computer-readable medium of claim 8, wherein the task template allows the entity value to be shared with additional tasks added to the checklist.

14. The non-transitory, computer-readable medium of claim 8, wherein the task includes a completion button that a user can select, and wherein a selection of the completion button causes a notification to be sent an administrator user device indicating that the task was completed.

15. A system for creating tasks for an action-based checklist, comprising:
a memory storage including a non-transitory, computer-readable medium comprising instructions; and
a computing device including a hardware-based processor that executes the instructions to carry out stages comprising:
receiving a body of text;
identifying a task template from a plurality of task templates based on words in the body of text that correspond to a task description in the task template;
parsing an utterance from the body of text using an example utterance in the task template;
identifying an entity value in the parsed utterance based on an example utterance;
inserting the entity value into at least one entity placeholder of the task template;
generating a task based on the task template and the inserted entity value; and
adding the task to a checklist of multiple tasks, wherein the checklist displays on a user device.

16. The system of claim 15, the stages further comprising sending the checklist to a user device associated with the body of text, and wherein the body of text is part of one of an email, a calendar invite, a text document, and a trouble ticket.

17. The system of claim 15, wherein a second task template is used to create a second task for the checklist, the second task template using, as an input, an output from the identified task template.

18. The system of claim 15, wherein task template includes a Uniform Resource Identifier component that causes the user device to perform a predefined action when selected, a description component that displays a description of the predefined action, and a completion criteria component that displays a requirement for completing the task.

19. The system of claim 18, wherein a graphical user interface for the checklist allows a user to add new tasks to the checklist and remove the generated task from the checklist.

20. The system of claim 15, wherein the task template allows the entity value to be shared with additional tasks added to the checklist.
